(19) United States
(12) Patent Application Publication
(10) Pub. No.: US 2007/0136108 A1
(43) Pub. Date: Jun. 14, 2007

(54) Class action settlement fund and method of funding a class action settlement using a mixture of cash and insurance

(76) Inventor: Bradley Scott Corsello, Bronx, NY (US)

Correspondence Address: Bradley Corsello;14th Floor, 485 Seventh Avenue, New York, NY, 10018, US

(21) Appl. No.: 11/591,030

(22) Filed: Nov. 1, 2006

Related U.S. Application Data
(60) Provisional application No. 60/749,514, filed on Dec. 12, 2005.

(51) Int. Cl. G06Q 40/00; G06Q 99/00

(52) U.S. Cl. 705/4; 705/1

(57) ABSTRACT

A class action settlement is funded by obtaining an insurance contract that is adapted to pay a benefit depending on the claims for cash payments made by class members. In one embodiment of the invention, an amount of cash sufficient to satisfy an estimated fraction of the total possible claims is deposited into a settlement fund, and a policy of insurance or similar contract is obtained that is adapted to pay a benefit sufficient to pay claims made in excess of the cash deposited into the fund.

### CROSS-REFERENCE TO RELATED APPLICATION

This application claims priority from provisional application Ser. No. 60/749,514, filed Dec. 12, 2005.

### BACKGROUND OF THE INVENTION

The present invention relates to a novel method of funding a class action settlement, and a novel class action settlement fund.

A class action is a litigation in which one or more representative plaintiffs represent the legal interests of a large number of similarly situated persons against one or more defendants. Class actions are provided for by the Federal Rules of Civil Procedure and the rules and laws of the States.

Class actions are often, but not always, aggregations of a large number of small claims, that is, claims for a relatively small sum of money. Because of the costs of litigation, it is often not worthwhile to litigate a small claim. A class action enables the small claims of many persons to be aggregated, such that the amount at issue is large enough to justify litigation. Thus, class actions enable the vindication of the rights of small claimants that would not otherwise be vindicated.

Many class actions are resolved by settlement, a process in which the parties compromise the claims and defenses made in the litigation to reach a negotiated resolution. When participating in settlement, the representative plaintiffs represent the interests of the entire class including the absent class members (i.e., those who are not named plaintiffs in the litigation). To protect the interests of the absent class members, settlements of class actions are subject to judicial supervision and approval.

The terms of a settlement agreement may include the following matters: the total amount of the judgment (i.e., the total amount of money that will be divided amongst the class members); a scheme of distribution (for example, it may be agreed that every class member will be entitled to an equal share of the judgment, or some other formula may be agreed upon); the details of settlement administration, including appointment of a claims administrator; and details of class notice and claims processing procedures and policies. There may be a need to identify the class members. In some cases class members can be identified by a review of the defendant's business records. In other cases, class members may have to identify themselves by providing, for example, proof of purchase. These are some of the matters that are routinely negotiated, agreed upon, and approved by the court in the settlement of class actions, and become terms of the settlement.

When a class action is settled on terms that call for payment of money to class members, provision must be made for funding the payments. Conventionally, a settlement fund is created, from which the payments to class members will be made. The settling defendant funds the settlement fund by depositing therein a sum of cash equal to the total amount of the claims payable to the class. For example, if the class has 500,000 members, and the settlement provides for payment of $20 to each class member, the fund would be funded with a cash deposit of $10,000,000. The cash deposit may be made all at once or in installments over time. The settling defendant may deposit additional cash into the fund to cover an award of attorneys' fees, plaintiffs' cost of litigation, and/or costs of administering the settlement. A third-party claims administrator is often appointed to hold the settlement fund and/or administer the settlement process.

After settlement, and at some time before or after the settlement fund is created, the members of the class are notified that a settlement has been reached and that they may make claims against the settlement fund during a predetermined claim period. Notice to the class is usually by first-class mail when the mailing addresses of class members are known. Notice can also be by means of electronic mail or publication. Methods of notice may be combined to achieve the goal of alerting the members of the class that their claims against the defendant have been settled. Class members may be provided with claim forms that may be filled out by the class members and returned to the claims administrator. Each class member who submits a valid and timely claim form would be paid a sum of money from the settlement fund by the claims administrator according to the plan of distribution. Usually, class members who do not return a valid claim form in time do not receive a payment from the settlement fund, although sometimes exceptions are made. Eventually, the claim period finally elapses and no further claim forms will be honored.

Thus, it remains a possibility that some of the cash in the settlement fund will not be claimed by class members. According to an empirical study of class action settlement response rates, in the majority of cases studied fewer than 20% of class members filed claims. 2 Newberg on Class Actions, Appendix 8-4 (3d ed. 1992). Another empirical study found class action settlement response rates ranging from 3 to 33%. Gail Hillebrand & Daniel Torrence, Claims Procedures in Large Consumer Class Actions and Equitable Distribution of Benefits, 28 Santa Clara L. Rev. 747 (1988). Thus, in most class action settlements, most of the money deposited in the settlement fund to finance payments to the class is left unclaimed. Usually, the money reverts back to the settling defendant after the claim period elapses, according to the agreed-upon terms of the settlement.

### SUMMARY OF THE INVENTION

According to the invention, a class action settlement is funded by depositing into a settlement fund an amount of cash or other property sufficient to satisfy an estimated fraction of the total possible claims, and by obtaining a policy of insurance or similar contract that is adapted to pay any claims made in excess of the cash deposited into the fund.

According to another aspect of the invention, a class action settlement fund comprises an amount of cash and an insurance policy or similar contract that is adapted to pay claims made in excess of the cash deposited into the fund.

The invention provides a great advantage in settling class actions because the settling defendant or defendants are not required to put up 100% of the total claimable amount in cash, as in a conventional settlement. Rather, they put up only a fraction (preferably based on an estimate of the claims likely to be made) of the total claimable amount, and pay the costs of obtaining a policy of insurance or similar contract. This enables the defendant or defendants to settle the litigation at a much lower out-of-pocket cost, greatly facilitating settlement. Payment of claims made above the amount of the cash deposit is guaranteed by the policy of insurance or similar contract. Even if an unusually large percentage (even up to 100%) of the class members file timely and valid claims, all of their claims will be paid in full. Thus, the interests of the class members are not impaired, even while the cost of settling the case is greatly reduced.

The invention enables settlement of class actions for a higher total amount (and thus a higher pro rata claim per member) than the prior art method that requires 100% cash funding of the settlement. Consider, for example, a class action involving 100,000 class members which the settling defendant or defendants wish to settle for a total of $3 million exclusive of attorneys' fees and costs. Under the prior art method, the entire $3 million would be deposited into a fund and each class member's equal share of the fund would be $30. According to the invention, a portion of the $3 million would be deposited as cash in the settlement fund and the remainder used to purchase a policy of insurance to cover any excess claims on the fund. The total of the cash deposit and the costs of obtaining the insurance policy might total, perhaps, 30% of the total possible claims (that amount will depend on the willingness of the insurance market to provide the insurance sought). In that case, the fund can satisfy up to $10 million in claims and each member can be offered $100 as his or her share of the fund instead of only $30. Thus, according to the invention the settlement provides a greatly enhanced benefit to the class members. This enhanced benefit comes at no additional cost to the settling defendants and at no cost to the class members who fail to make claims against the fund. It is made possible, according to the instant invention, by exploitation of the fact that most class members will not be expected to make claims on the fund, which provides an opening for a insurer to take the risk (for a price) that claims will be made in excess of expectations.

A class action settlement is subject to approval by the court with jurisdiction over the action. It was not known prior to the invention whether courts would approve a settlement according to the present invention.

### DETAILED DESCRIPTION OF THE INVENTION

According to one aspect of the invention, a novel method is used to fund a class action settlement. The method comprises the steps of depositing into a settlement fund an amount of cash sufficient to satisfy some of the total possible claims, and by obtaining a policy of insurance or similar contract that is adapted to pay any claims made in excess of the cash deposit (“excess claims”). The cash deposit may be made all at once or in installments over time. The order in which the steps are performed is not important. When both steps are complete, a settlement fund is created from which all claims made on the fund by class members can be paid.

With respect to the step of depositing an amount of cash into the settlement fund, it is preferable to estimate the fraction of the claims that are likely to be made against the fund by class members and to deposit at least enough cash or other property to enable payment of that estimated fraction of claims. The estimation may be performed in any reasonable manner, and may include consideration of numerous factors specific to the class action being settled and the terms and administrative details of the settlement. Factors to be considered may include: the number of class members, the nature of the underlying class action, the amount each class member can expect to receive upon making a claim, the age demographics of the class members, the gender demographics of the class members, the amount of publicity the case has received, the amount of publicity the settlement will receive, the timing of notices that will be provided to the class, the number of notices that will be provided to the class, the form of notices that will be provided to the class, the amount of time class members will have to submit claim forms, whether the class member must provide proof of purchase or some other evidence to have a valid claim, the relative difficulty of making a valid claim, the proportion of the claim amount to the price of the product (if any) underlying the class action, and historical data and experience regarding redemption rates from similar settlements.

In making an estimate it is not essential to predict with exactness the total amount of claims that will be made against the fund. Rather, it is more to the point to estimate a ceiling that the total amount of claims is unlikely to exceed. Estimates of this nature are known to be made in the context of providing insurance against over-redemption of promotional offerings such as coupons that could be redeemed for cash off the purchase price of a product or service, or rebate coupons that could be redeemed for a rebate of cash following the purchase of a product or service.

The policy of insurance may be a traditional insurance policy, having a deductible and premium, provided by an insurance company or underwriter. Also suitable would be a contract in which a company agrees to bear the risk of excess claims. The deductible may be approximately equal or exactly equal to the sum of cash deposited into the settlement fund. The cost of obtaining the policy of insurance or other contract may include an insurance premium, taxes, and brokerage fees. Preferably, the insurance policy or other contract is drafted to be free of exclusions and exceptions that would unreasonably impair the security of the class members. Preferably, the settlement fund itself is the beneficiary (or the payee of any proceeds) of the insurance policy or similar contract.

As a practical matter, in order to obtain the policy of insurance from the insurance market, the amount of cash deposited in the settlement fund will have to be sufficient to satisfy the insurer writing the policy that taking on the risk of paying excess claims is a reasonable risk. The cash is essentially the deductible on the insurance policy, and for a price (the premium on the policy) the insurer takes the risk that claims will be made in excess of the deductible.

In the event that excess claims are made against the settlement fund, a party (preferably the claims administrator) will notify the company or underwriter that wrote the insurance policy or similar contract of the fact of excess claims and their amount. The company would then pay out, according to the terms of the insurance policy or similar contract, a sum of cash at least equal to the excess claims, which sum of cash would be deposited into the settlement fund by the claims administrator or other party. Thus, all of the claims against the settlement fund would be payable from the cash in the fund, part of which was deposited initially by the defendant and part of which was paid out according to the terms of the insurance policy. In the event that no excess claims are made, there would be no payout on the insurance policy, and all claims would be payable from the cash that was deposited initially. In the event that the claims made are less than the amount of cash initially deposited, there could still be cash left over in the fund after all claims made against it are paid. In such an instance, the leftover cash in the fund could revert to the possession of the defendant or could be applied to some other use, such as a donation to a charitable purpose or other public purpose, according to the terms of the settlement agreement.

In a preferred embodiment of the invention, the insurance policy provides sufficient coverage to guarantee payment of all excess claims, even if up to 100% of the class members made valid claims. For example if, according to the terms of a settlement, the total claimable amount is $10 million and the cash deposit is $3 million, the insurance policy would be adapted to pay if claims exceeded $3 million, with a coverage limit of $7 million (sufficient to ensure that all claims are paid). Policies covering less total risk would likely be available from the insurance market at a lower cost. In view of the extreme unlikelihood that 100% of the class members would make valid claims, in alternative embodiments of the invention, the insurance policy may be adapted to guarantee payment of the excess claims (i.e. the claims in excess of the cash deposited into the fund) up to a maximum that is less than 100% of the total possible excess claims. According to these alternative embodiments, the insurance policy may be adapted to guarantee payment of excess claims in the ranges of 20 to 30 percent, 30 to 40 percent, 40 to 50 percent, 50 to 60 percent, 60 to 70 percent, 70 to 80 percent, 80 to 90 percent, or 90 to 100 percent of the excess claims.

The security of the class members can be further improved obtaining a second policy of insurance, or a surety bond, adapted to pay excess claims against the fund that the original policy of insurance fails to pay.

In an alternative embodiment of the invention, several insurance policies could be obtained, each covering a different portion of excess claims. For example, a first policy could cover the first 20% of excess claims, and a second policy could cover the remaining 80%.

In addition to the cash deposited into the settlement fund to cover claims made against it by class members, additional cash might be deposited to pay attorneys' fees, the plaintiffs' costs of litigation, and/or the cost of administering the fund and claims processing. According to another aspect of the invention, a novel class action settlement fund is created according to one of the methods described above.

According to another aspect of the invention, a class action settlement fund comprises an amount of cash and an insurance policy or similar contract that is adapted to pay claims made in excess of an estimated fraction of the total possible claims. The settlement fund might be held in a bank account, in an escrow account, or in a trust. The fund may be held by or in the name of an independent claims administrator appointed to administer the class action settlement. Preferably, the amount of cash is at sufficient to cover at least an estimated amount of claims likely to be made against the settlement fund. The estimation may include consideration of various factors as described above in connection with the novel method of the invention. The settlement fund may further comprise a second policy of insurance adapted to pay any claims that the policy of insurance fails to pay. The settlement fund may further comprise a surety bond that will be payable if the policy of insurance fails to pay claims. Preferably, the policy of insurance, second policy of insurance if any, and surety bond if any are adapted to make the settlement fund itself the beneficiary or payee of the policy or bond. Alternatively, the claims administrator might be made the beneficiary or payee.

According to another aspect of the invention, an insurance policy is adapted to pay all claims against a class action settlement fund in excess of an amount of cash deposited in the fund. Alternatively, an insurance policy is adapted to pay claims against a class action settlement fund in excess of an amount of cash deposited in the fund up to a maximum amount equal to a predetermined percentage of the excess claims. Preferably the amount of cash deposited in the fund is at least sufficient to cover an estimated fraction of the claims likely to be made on the settlement fund by class members. The cash deposited in the fund may be considered the deductible for the insurance policy.

It is to be understood that when reference is made herein to an insurance contract paying claims against a class action settlement fund, the payment of claims may be made indirectly by paying a lump sum benefit into the fund, from which the payments of claims will be made to class members by, for example, mailing checks drawn on the settlement fund. Alternatively, the insurance contract may pay claims directly to class members instead of to the fund.

Guidelines to Interpretation and Construction

Claim terms shall have their ordinary English meaning unless expressly defined otherwise herein or during prosecution of the application.

No claim element is intended to be interpreted as a means-plus-function or step-plus-function claim element.

No claim includes a step of estimating, unless expressly specified in the claim. In carrying out the invention an estimate could be adopted from elsewhere, e.g. the Santa Clara Law Review article cited in the Background of the Invention suggests that it is highly unlikely that more than 33% of the members of any class action will respond to an offer to claim a benefit from the settlement fund. That could be a reasonable estimated fraction and could be adopted directly.

This application for patent is not intended to dedicate any subject matter to the public. In particular, an apparent failure to claim a disclosed subject matter is not intended to dedicate any subject matter to the public for doctrine of equivalents purposes or otherwise.

I claim:

1. A class action settlement fund for paying valid demands by class members for settlement awards, comprising an insurance contract adapted to pay a benefit sufficient to pay at least some of the total amount of the demands if the total amount of the demands exceeds a predetermined amount.

2. The fund of claim 1 further comprising an amount of cash.

3. The fund of claim 2 wherein the predetermined amount is equal to or less than the amount of cash.

4. The fund of claim 1 wherein the insurance contract is adapted to pay a benefit equal to all or substantially all of the total amount of the demands in excess of the predetermined amount.

5. The fund of claim 1 wherein the predetermined amount is equal to or less than an estimate of the total amount of settlement claims that class members are likely to demand.

6. The fund of claim 1 wherein the insurance contract is a first insurance contract, and wherein the fund further comprises a second insurance contract adapted to pay a benefit if the total amount of demands exceeds the predetermined amount and the the first insurance contract fails to pay a benefit sufficient to pay all demands in excess of the predetermined amount.

7. The fund of claim 1 wherein an amount of potential excess claims equals the total amount of all potential demands for settlement benefits by class members, minus the predetermined amount, and the insurance contract is adapted to pay the benefit up to a limit, the limit being a predetermined percentage of the potential excess claims.

8. The fund of claim 3 wherein the amount of cash is a first amount of cash and the fund further comprises a second amount of cash.

9. The fund of claim 1 wherein the insurance contract has a beneficiary, and the fund is the beneficiary.

10. A method of funding a class action settlement in which awards will be delivered to class members making valid demands for awards, the method comprising the step of obtaining an insurance contract adapted to pay out a benefit, the amount of the benefit depending on a total amount of the demands.

11. The method of claim 10 further comprising the step of depositing an amount of cash into a fund and wherein the insurance contract is adapted to pay out a benefit if the total amount of the demands exceeds of the amount of cash.

12. The method of claim 11 wherein the insurance contract is adapted to pay out a benefit equal to all or substantially all of the demands made in excess of the amount of cash.

13. The method of claim 11 wherein the amount of cash is equal to or greater than an estimate of the total amount of awards that class members are likely to validly demand.

14. The method of claim 10 wherein the insurance contract is a first insurance contract, and wherein the method further comprises a step of obtaining a second insurance contract adapted to pay a benefit if the first insurance contract fails to pay a benefit.

15. The method of claim 11 wherein the amount of cash is a first amount of cash, the insurance contract is adapted to pay a benefit equal to at least some of the demands in excess of the first amount of cash, and the method further comprises the step of depositing a second amount of cash into the fund.

16. An insurance contract adapted to insure against the risk that demands for class action settlement awards by members of a class will exceed a predetermined amount, by paying a benefit if said demands exceed said predetermined amount.

17. A method of providing a settlement of a class action involving cash payments to class members making valid demands for said cash payments, the method comprising the steps of
(a) providing an amount of cash;
(b) obtaining an insurance contract adapted to pay a benefit sufficient to satisfy at least some of the demands if a predetermined condition is met;
(c) receiving at least one valid demand from a class member;
(d) determining whether the predetermined condition is met;
(e) if the predetermined condition is met, collecting the benefit from the insurance contract;
(f) responding to the at least one demand by paying at least part of the amount of cash to the class member.

18. The method of claim 17 further comprising the step of
(g) responding to the at least one demand for a cash payment by paying at least part of the benefit to the class member.

19. The method of claim 17 wherein the predetermined condition is that the total amount of the at least one demand exceeds a predetermined amount.

20. A method of providing a settlement of a class action involving cash payments to class members making valid claims for said cash payments, the method comprising the steps of
(a) depositing an amount of cash into a settlement fund, the first amount of cash being at least equal to an estimate of the total amount of valid claims that are likely to be made;
(b) obtaining an insurance contract adapted to pay a benefit if the total amount of valid claims exceeds the amount of cash;
(c) receiving at least one valid claim;
(d) determining the total amount of valid claims;
(e) if the total amount of valid claims exceeds amount of cash, obtaining the benefit;
(f) paying at least one of the valid claims from the fund.
